(19) United States
(12) Patent Application Publication
(10) Pub. No.: US 2021/0039649 A1
(43) Pub. Date: Feb. 11, 2021

(54) VEHICLE CONTROL DEVICE, VEHICLE CONTROL METHOD, AND MEDIUM

(71) Applicant: HONDA MOTOR CO., LTD., Tokyo (JP)

(72) Inventor: Kaijiang Yu, Wako-shi (JP)

(21) Appl. No.: 16/983,005

(22) Filed: Aug. 3, 2020

(30) Foreign Application Priority Data
Aug. 5, 2019 (JP) 2019-143597

(51) Int. Cl. B60W 30/18; G06K 9/00; G08G 1/056; G08G 1/00

(52) U.S. Cl. CPC B60W 30/18159; G06K 9/00791; G06K 2209/23; G08G 1/20; B60W 30/18163; G08G 1/056

(57) ABSTRACT

When a vehicle heads from a first road toward a second road which at least partially intersects with the first road while traveling, other vehicle heads from the second road to a first road side, and a future trajectory in which the vehicle travels and a future trajectory in which the other vehicle travels intersect with each other, a vehicle control device determines whether to cause the vehicle to pass through an intersection area in which the first road and the second road intersect with each other with priority over the other vehicle on the basis of the state of the vehicle and the future position of the other vehicle and controls the vehicle on the basis of a result of the determination.

### CROSS-REFERENCE TO RELATED APPLICATION

Priority is claimed on Japanese Patent Application No. 2019-143597, filed Aug. 5, 2019, the content of which is incorporated herein by reference.

### BACKGROUND

### Field

The present invention relates to a vehicle control device, a vehicle control method, and a storage medium.

### Description of Related Art

Conventionally, a merging support device that supports a vehicle in merging from a first lane into a second lane is known (for example, refer to Patent Literature 1). This merging support device calculates a travel distance B until the vehicle stops at a preset deceleration, acquires a distance A from the vehicle to a reference point in the first lane during a period from a starting time of acceleration to a starting time of a lane change, and stops merging support under a condition that a value obtained by subtracting the travel distance B from the distance A is smaller than a preset threshold value (Japanese Unexamined Patent Application, First Publication No. 2017-124743, Japanese Unexamined Patent Application, First Publication No. 2016-210380).

However, there are cases in which it is not possible to cause the vehicle to travel more smoothly in the conventional technology.

### SUMMARY

The present invention has been made in view of such circumstances, and an object thereof is to provide a vehicle control device, a vehicle control method, and a medium which can allow a vehicle to travel more smoothly.

The vehicle control device, the vehicle control method, and the storage medium according to the present invention have adopted the following configuration.

(1): A vehicle control device according to one aspect of the present invention is a vehicle control device that includes an acquirer configured to acquire a state of a vehicle, a current position of another vehicle present in surroundings of the vehicle, and a predicted future position of the other vehicle, and an action controller configured to control an action of the vehicle on the basis of information acquired by the acquirer, in which, when the vehicle heads from a first road toward a second road which at least partially intersects with the first road while traveling, the other vehicle heads from a second road toward a first road, and a future trajectory in which the vehicle travels and a future trajectory in which the other vehicle travels intersect with each other, the action controller determines whether to cause the vehicle to pass through an intersection area in which the first road and the second road intersect with each other with priority over the other vehicle on the basis of the state of the vehicle and the future position of the other vehicle, and controls the vehicle on the basis of a result of the determination.

(2): In the aspect of (1) described above, the first road is a road that merges with the second road and disappears after a predetermined distance, and the second road is a road that does not disappear after the predetermined distance, or the second road is a road that merges with the first road and disappears after a predetermined distance, and the first road is a road that does not disappear after the predetermined distance.

(3): In the aspect of (1) or (2) described above, the vehicle control device further includes a recognizer configured to recognize surrounding conditions of the vehicle, and a predictor configured to predict a future position of the other vehicle on the basis of a result of the recognition performed by the recognizer, in which the acquirer acquires a current position of the other vehicle recognized by the recognizer from the recognizer and acquires a future position of the other vehicle predicted by the predictor from the predictor.

(4): In the aspect of any one of (1) to (3) described above, the other vehicle is a vehicle that travels in front of the vehicle.

(5): In the aspect of any one of (1) to (4) described above, when a timing at which the other vehicle will reach the intersection area is within a predetermined time from a timing at which the vehicle will reach the intersection area, the action controller determines whether to cause the vehicle to pass through the intersection area with priority over the other vehicle.

(6): In the aspect of any one of (1) to (5) described above, the action controller causes the vehicle to pass through the intersection area with priority over the other vehicle by causing the vehicle to pass through the intersection area at an earlier timing than a timing at which the other vehicle will pass through the intersection area.

(7): In the aspect of any one of (1) to (5) described above, the action controller causes the vehicle to pass through the intersection area with priority over the other vehicle by causing the vehicle to enter the second road from the first road in front of the other vehicle in the intersection area.

(8): In the aspect of any one of (1) to (7) described above, when a density of vehicles on a road on which the other vehicle is present exceeds a threshold value or when an average speed of vehicles traveling on the road on which the other vehicle is present is equal to or less than a threshold value, the action controller determines whether to cause the vehicle to pass through the intersection area with priority over the other vehicle, and controls the vehicle on the basis of a result of the determination.

(9): In the aspect of any one of (1) to (8) described above, the action controller determines whether to cause the vehicle to pass through the intersection area with priority over the other vehicle and controls the vehicle on the basis of a result of the determination in a road environment in which the first road extends without disappearing in a vicinity of the intersection area on the first road and ahead of the intersection area in a traveling direction of the vehicle.

(10): In the aspect of (9) described above, an exit of a specific road including the first road and the second road is provided ahead of the intersection area on the first road in a traveling direction of the vehicle.

(11): In the aspect of any one of (1) to (10) described above, when the vehicle approaches a predetermined distance from an end point of the intersection area, the action controller does not execute processing of determining whether to cause the vehicle to pass through the intersection area with priority over the other vehicle and controlling the vehicle on the basis of a result of the determination.

(12): In the aspect of any one of (1) to (11) described above, when there is a vehicle in front that is predicted to pass through the intersection area in front of the vehicle on the road on which the vehicle travels, the action controller executes processing of determining whether to overtake the vehicle in front and to cause the vehicle to pass through the intersection area with priority over the other vehicle, and controlling the vehicle on the basis of a result of the determination.

(13): In the aspect of (12) described above, the action controller determines whether to overtake the vehicle in front and to cause the vehicle to pass through the intersection area with priority over the other vehicle on the basis of a distribution of a vehicle group including the vehicle, the vehicle in front, and the other vehicle, and speed of vehicles included in the vehicle group.

(14): A vehicle control method according to another aspect of the present invention includes, by a computer, acquiring a state of a vehicle, a current position of other vehicle present in surroundings of the vehicle, and a predicted future position of the other vehicle, controlling an action of the vehicle on the basis of the acquired information, and, when the vehicle heads from a first road toward a second road which at least partially intersects with the first road while traveling, the other vehicle heads from a second road toward a first road side, and a future trajectory in which the vehicle travels and a future trajectory in which the other vehicle travels intersect with each other, determining whether to cause the vehicle to pass through an intersection area in which the first road and the second road intersect with each other with priority over the other vehicle on the basis of the state of the vehicle and the future position of the other vehicle, and controlling the vehicle on the basis of a result of the determination.

(15): A storage medium that stores a program according to still another aspect of the present invention is a storage medium which causes a computer to acquire a state of a vehicle, a current position of other vehicle present in surroundings of the vehicle, and a predicted future position of the other vehicle, control an action of the vehicle on the basis of the acquired information, and, when the vehicle heads from a first road toward a second road which at least partially intersects with the first road while traveling, other vehicle heads from a second road toward a first road side, and a future trajectory in which the vehicle travels and a future trajectory in which the other vehicle travels intersect with each other, determine whether to cause the vehicle to pass through an intersection area in which the first road and the second road intersect with each other with priority over the other vehicle on the basis of the state of the vehicle and the future position of the other vehicle, and control the vehicle on the basis of a result of the determination.

According to (1) to (15), the vehicle control device determines whether to cause the vehicle to pass through the intersection area in which the first road and the second road intersect with each other with priority over the other vehicle, and controls the vehicle on the basis of a result of the determination, thereby allowing the vehicle to travel more smoothly.

According to (12), the vehicle control device determines whether to overtake the vehicle in front and to cause the vehicle to pass through the intersection area with priority over the other vehicle, and controls the vehicle on the basis of a result of the determination, thereby allowing the vehicle to travel more smoothly.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram for describing specific control.

FIG. 4 is a diagram (part 1) which shows an example of a situation in which a vehicle passes through an intersection area with priority over other vehicles.

FIG. 5 is a diagram (part 2) which shows an example of the situation in which a vehicle passes through an intersection area with priority over other vehicles.

FIG. 6 is a diagram (part 3) which shows an example of the situation in which a vehicle passes through an intersection area with priority over other vehicles.

FIG. 7 is a diagram which shows an example of a situation in which a vehicle of a comparative example enters a second road without executing specific control.

FIG. 8 is a diagram which shows an example of a situation in which a vehicle executes specific control and enters the second road.

FIG. 9 is a flowchart which shows an example of a flow of processing executed by an automated driving control device.

FIG. 10 is a diagram which shows an example of a situation in which specific control in a second embodiment is executed.

FIG. 11 is a diagram which shows an example of a situation in which specific control in a third embodiment is executed.

FIG. 12 is a flowchart which shows an example of a flow of processing executed by an automated driving control device according to the third embodiment.

FIG. 13 is a diagram which shows an example of functional constituents of an automated driving control device according to a fourth embodiment.

FIG. 14 is a diagram which shows an example of functional constituents of a vehicle control system according to a fifth embodiment.

FIG. 15 is a diagram which shows an example of a hardware configuration of the automated driving control device according to the embodiment.

### DETAILED DESCRIPTION

Hereinafter, embodiments of a vehicle control device, a vehicle control method, and a storage medium of the present invention will be described with reference to the drawings.

### First Embodiment

### Overall Configuration

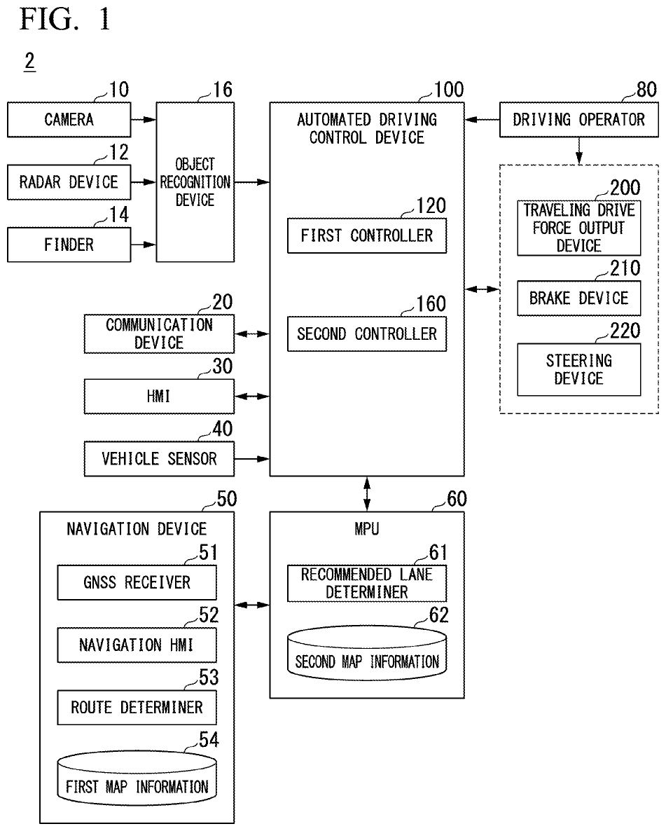

FIG. 1 is a configuration diagram of a vehicle system 2 using a vehicle control device according to an embodiment. A vehicle in which the vehicle system 2 is mounted is, for example, a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or electric power discharged from a secondary battery or a fuel cell.

The vehicle system 2 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. These devices or apparatuses are connected to each other by a multiplex communication line such as a controller area network (CAN) communicator line, a serial communication line, a wireless communication network, or the like. The configuration shown in FIG. 1 is merely an example, and part of the configuration may be omitted or another configuration may be added.

The camera 10 is, for example, a digital camera using a solid-state imaging device such as a charge coupled device (CCD) or a complementary metal oxide semiconductor (CMOS). The camera 10 is attached to an arbitrary position of a vehicle in which the vehicle system 2 is mounted (hereinafter, a host vehicle M). When the front is imaged, the camera 10 is attached to an upper part of the front windshield, a back of the rearview mirror, or the like. The camera 10 periodically repeats to image the surroundings of the host vehicle M. The camera 10 may also be a stereo camera.

The radar device 12 radiates radio waves such as millimeter waves to the surroundings of the host vehicle M, and detects at least a position (a distance and an orientation) of an object by detecting radio waves (reflected waves) reflected by the object. The radar device 12 is attached to an arbitrary part of the host vehicle M. The radar device 12 may detect the position and a speed of the object using a frequency modulated continuous wave (FM-CW) method.

The finder 14 is a light detection and range (LIDAR). The finder 14 radiates light to the surroundings of the host vehicle M and measures scattered light. The finder 14 detects a distance to the object on the basis of time from light emission and light reception. The radiated light is, for example, pulsed laser light. The finder 14 is attached to an arbitrary part of the host vehicle M.

The object recognition device 16 performs sensor fusion processing on a result of detection performed by some or all of the camera 10, the radar device 12, and the finder 14, and recognizes the position, type, speed, and the like of the object. The object recognition device 16 outputs a result of the recognition to the automated driving control device 100. The object recognition device 16 may output results of detections by the camera 10, the radar device 12, and the finder 14 to the automated driving control device 100 as they are. The object recognition device 16 may be omitted from the vehicle system 2.

The communication device 20 uses, for example, a cellular network, a Wi-Fi network, a Bluetooth (a registered trademark), a dedicated short range communication (DSRC), or the like, and communicates with other vehicle present in the surroundings of the host vehicle M or communicates with various types of server devices via wireless base stations.

The HMI 30 presents various types of information to an occupant of the host vehicle M and receives an input operation from the occupant. The HMI 30 includes various display devices, speakers, buzzers, touch panels, switches, keys, and the like.

The vehicle sensor 40 includes a vehicle speed sensor that detects the speed of the host vehicle M, an acceleration sensor that detects the acceleration, a yaw rate sensor that detects an angular speed around a vertical axis, an orientation sensor that detects a direction of the host vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M on the basis of a signal received from a GNSS satellite. The position of the host vehicle M may be identified or supplemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route (hereinafter, a route on a map) from the position (or an arbitrary input position) of the host vehicle M identified by the GNSS receiver 51 to a destination input from the occupant using the navigation HMI 52 with reference to the first map information 54. The first map information 54 is, for example, information in which a road shape is expressed by a link indicating a road and a node connected by the link. The first map information 54 may include curvature of a road, point of interest (POI) information, and the like. The route on a map is output to the MPU 60. The navigation device 50 may perform route guidance using the navigation HMI 52 on the basis of the route on a map. The navigation device 50 may be realized by, for example, a function of a terminal device such as a smart phone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in the storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane to travel from the left.

When there is a branch point in the route on a map, the recommended lane determiner 61 determines a recommended lane such that the host vehicle M travels in a reasonable route for traveling to a branch destination.

The second map information 62 is map information with higher accuracy than the first map information 54. The second map information 62 includes, for example, information on a center of a lane, information on a boundary of the lane, or the like. The second map information 62 may include road information, traffic regulation information, address information (addresses/postal codes), facility information, telephone number information, and the like. The second map information 62 may be updated at any time by the communication device 20 communicating with another device.

The driving operator 80 includes, for example, an accelerator pedal, a brake pedal, a shift lever, a steering wheel, a modified steer, a joystick, and other operators. A sensor that detects an operation amount or a presence or absence of an operation is attached to the driving operator 80, and this detection result is output to the automated driving control device 100 or some or all of the traveling drive force output device 200, the brake device 210, and the steering device 220.

The automated driving control device 100 includes, for example, a first controller 120 and a second controller 160. Each of the first controller 120 and the second controller 160 is realized by, for example, a hardware processor such as a central processing unit (CPU) executing a program (software). Some or all of these components may be realized by hardware (a circuit; including circuitry) such as a large scale integration (LSI), an application specific integrated circuit (ASIC), a field-programmable gate array (FPGA), or a graphics processing unit (GPU) and may also be realized by a cooperation of software and hardware. The program may be stored in advance in a storage device (a storage device including a non-transitory storage medium) such as an HDD or a flash memory of the automated driving control device 100, or may be stored in a detachable storage medium such as a DVD or a CD-ROM and installed in the HDD or flash memory of the automated driving control device 100 by the storage medium (the non-transitory storage medium) being mounted on a drive device. The automated driving control device 100 is an example of the “vehicle control device,” and a combination of the action plan generator 140 and the second controller 160 is an example of the “action controller.”

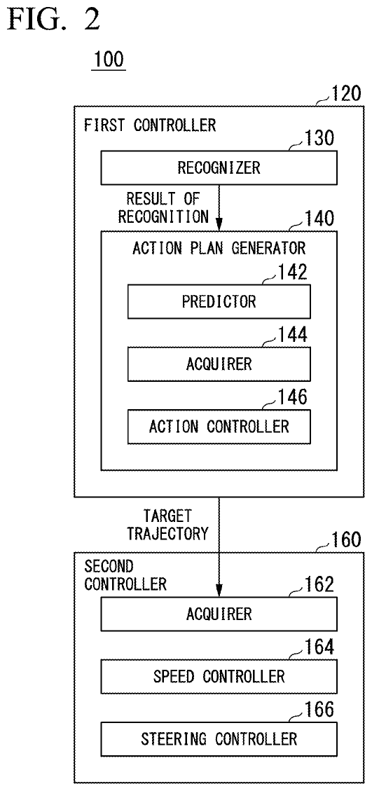

FIG. 2 is a functional configuration diagram of the first controller 120 and the second controller 160. The first controller 120 includes, for example, a recognizer 130 and an action plan generator 140. The first controller 120 realizes, for example, a function based on artificial intelligence (AI) and a function based on a model given in advance in parallel. For example, a function of “recognizing an intersection” may be realized by executing a recognition of an intersection by deep learning or the like and a recognition based on conditions (including pattern matching signals, road markings, and the like) given in advance in parallel and comprehensively evaluating the both by scoring them. As a result, a reliability of automated driving is guaranteed.

The recognizer 130 recognizes states such as a position, a speed, and an acceleration of an object in the surroundings of the host vehicle M on the basis of information input from the camera 10, the radar device 12, and the finder 14 via the object recognition device 16. Specifically, the recognizer 130 recognizes conditions such as the position, speed, and acceleration of an object in the vicinity of the host vehicle M. The position of the object is, for example, recognized as a position on absolute coordinates having the origin at a representative point (a center of gravity, a center of a drive axis, or the like) of the host vehicle M, and is used for control. The position of the object may be represented by a representative point such as a center of gravity or a corner of the object, or may be represented by an expressed area. A “state” of the object may include the acceleration or jerk of the object, or an “action state” (for example, whether a lane change is being performed or is intended to be performed).

The action plan generator 140 travels, in principle, a recommended lane determined by the recommended lane determiner 61, and further generates a target trajectory in which the host vehicle M will travel automatically (independently from an operation of a driver) to be able to respond to the surrounding conditions of the host vehicle M. The target trajectory includes, for example, a speed element. For example, the target trajectory is expressed as a sequential arrangement of points (trajectory points) to be reached by the host vehicle M. The trajectory points are points to be reached by the host vehicle M for each predetermined traveling distance (for example, about several [m]) in a road distance, and, apart from this, a target speed and a target acceleration for each predetermined sampling time (for example, about several tenths of a [sec]) are generated as part of the target trajectory. The trajectory points may be positions to be reached by the host vehicle M at a corresponding sampling time for each predetermined sampling time. In this case, information on the target speed and the target acceleration is expressed by intervals between the trajectory points.

The action plan generator 140 may set an event of automated driving in generating a target trajectory. The event of automated driving includes a constant speed driving event, a low speed following driving event, a lane change event, a branching event, a merging event, a takeover event, and the like. The action plan generator 140 generates a target trajectory in accordance with an activated event. The action plan generator 140 generates a target trajectory by adding a result of processing performed by an action controller 146 to be described below, for example, when generating the target trajectory.

The action plan generator 140 includes, for example, a predictor 142, an acquirer 144, and an action controller 146. The predictor 142 predicts a future position of other vehicle present in the surroundings of the vehicle M on the basis of a result of recognition performed by the recognizer 130. For example, the predictor 142 predicts a direction in which other vehicle travels or a position at which the other vehicle will be present after a predetermined time on the basis of a behavior (a vehicle speed, an acceleration, or a traveling direction) or a past action history of the other vehicle. The acquirer 144 acquires a current position of the other vehicle recognized by the recognizer 130 from the recognizer 130 and a future position of the other vehicle predicted by the predictor 142 from the predictor 142. The acquirer 144 acquires the state (the vehicle speed, acceleration, or traveling direction) or the like of the vehicle M.

The action controller 146 controls an action of a vehicle on the basis of information acquired by the acquirer 144. Details of processing of the action controller 146 will be described.

The second controller 160 controls the traveling drive force output device 200, the brake device 210, and the steering device 220 such that the host vehicle M passes through the target trajectory generated by the action plan generator 140 at a scheduled time.

Returning to FIG. 2, the second controller 160 includes, for example, an acquirer 162, a speed controller 164, and a steering controller 166. The acquirer 162 acquires information on the target trajectory (trajectory points) generated by the action plan generator 140, and stores it in a memory (not shown). The speed controller 164 controls the traveling drive force output device 200 or the brake device 210 on the basis of a speed element associated with the target trajectory stored in the memory. The steering controller 166 controls the steering device 220 in accordance with a bending degree of the target trajectory stored in the memory. Processing of the speed controller 164 and the steering controller 166 is realized by, for example, a combination of feed forward control and feedback control. As an example, the steering controller 166 executes a combination of the feed forward control in accordance with curvature of a road in front of the host vehicle M and the feedback control based on a deviation from the target trajectory.

The traveling drive force output device 200 outputs a traveling drive force (torque) for a traveling of a vehicle to drive wheels. The traveling drive force output device 200 includes, for example, a combination of an internal combustion engine, an electric motor, a transmission, and the like, and an electronic control unit (ECU) that controls these. The ECU controls the constituents described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure to the cylinder, and a brake ECU. The brake ECU controls the electric motor according to the information input from the second controller 160 or the information input from the driving operator 80 such that a brake torque corresponding to a braking operation is output to each wheel. The brake device 210 may include, as a backup, a mechanism that transmits the hydraulic pressure generated by an operation of the brake pedal included in the driving operator 80 to the cylinder via a master cylinder. The brake device 210 is not limited to the configuration described above, and may be an electronically controlled hydraulic brake device that controls an actuator according to the information input from the second controller 160 and transmits the hydraulic pressure of the master cylinder to the cylinder.

The steering device 220 includes, for example, a steering ECU and an electric motor. The electric motor changes a direction of a steering wheel by applying a force to, for example, a rack and pinion mechanism. The steering ECU drives an electric motor according to the information input from the second controller 160 or the information input from the driving operator 80, and changes the direction of the steering wheel.

### Outline of Specific Control

In a case in which the vehicle M is traveling from a first road toward a second road side intersecting with at least part of the first road and the other vehicle is traveling from a second road toward a first road side, when a future trajectory in which the vehicle M will travel and a future trajectory in which the other vehicle will travel intersect with each other, the action controller 146 determines whether to cause the vehicle M to pass through an intersection area in which the first road and the second road intersect with each other with priority over the other vehicle on the basis of the state of the vehicle and the future position of the other vehicle. Then, the action controller 146 controls the vehicle M on the basis of a result of the determination. As described above, the action controller 146 determining whether to cause the vehicle M to pass through the intersection area with priority over the other vehicle and controlling the vehicle M on the basis of a result of the determination may be referred to as “specific control” in the following description. The first road is a merging road (a road that connects to another road, a road that merges with another road), and the second road is a merged road (a main line, a road with which a merging road merges). Alternatively, the first road is a merged road and the second road is a merging road. “Intersecting with at least part of the first road” described above includes intersecting with some of a plurality of lanes included in the first road, and intersecting with all of the plurality of lanes.

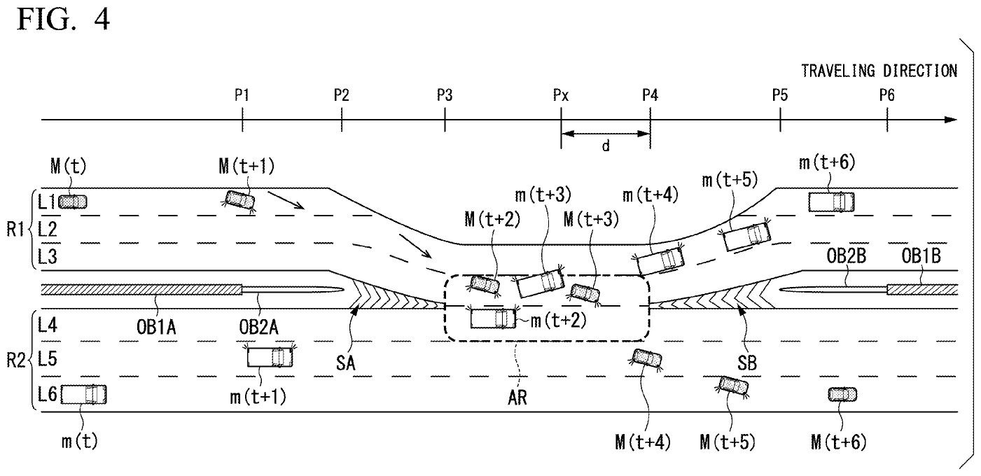

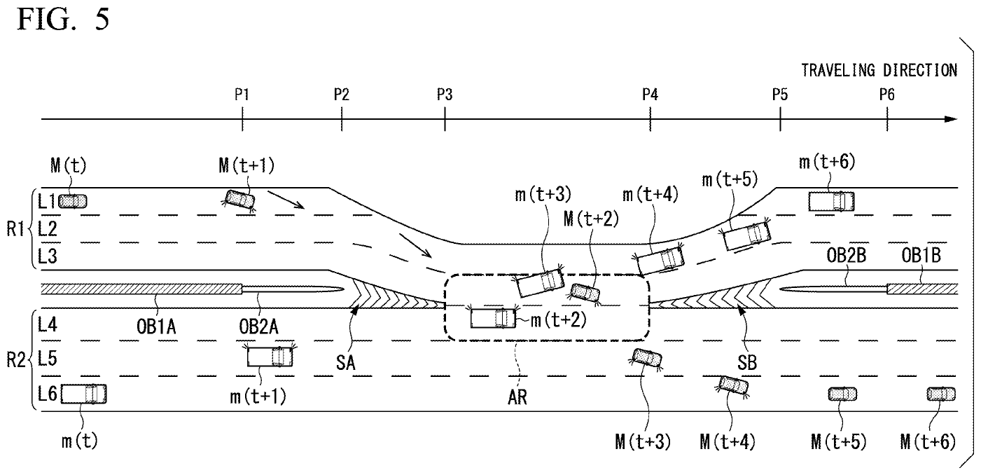

The action controller 146 causes, for example, the vehicle to pass through (refer to FIG. 4 to be described below) the intersection area with priority over the other vehicle by causing the vehicle to enter from the first road to the second road in front of the other vehicle in the intersection area. The action controller 146 causes, for example, the vehicle to pass through the intersection area with priority over the other vehicle by causing the vehicle to pass through the intersection area at an earlier timing than a timing at which the other vehicle passes through the intersection area (refer to FIG. 5 to be described below).

The action controller 146 determines whether to cause the vehicle to pass through the intersection area with priority over the other vehicle and controls the vehicle on the basis of a result of the determination in a road environment in which the first road extends without disappearing in a vicinity of the intersection area on the first road and on a traveling direction side of the vehicle M rather than the intersection area (ahead of the intersection area in traveling direction of the vehicle).

### Description of Specific Control

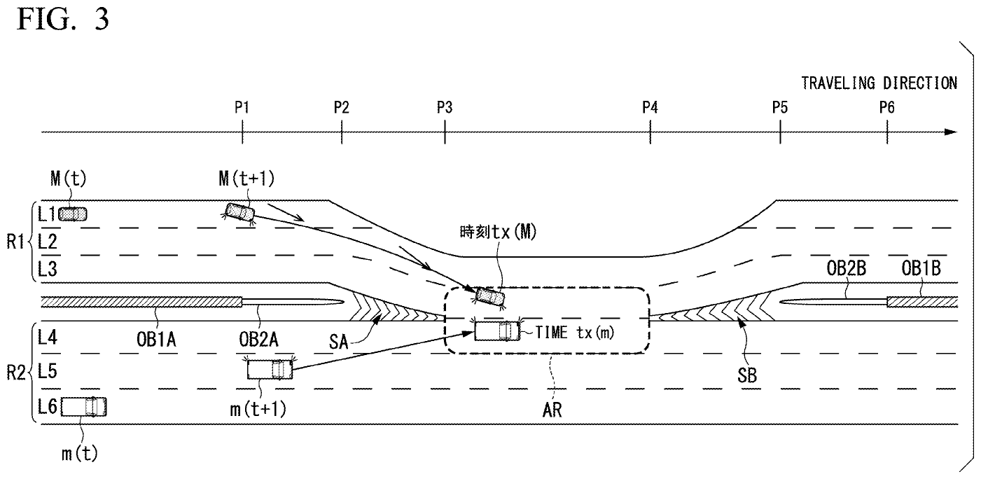

FIG. 3 is a diagram for describing specific control. In FIG. 3, a first road R1 has a road environment in which the first road R1 merges with a second road R2. The first road R1 is a merging road that merges with the second road R2, and the second road R2 is a main line and a merged road to which the first road R1 is connected. An area in which the first road R1 and the second road R2 merge is an intersection area AR. In other words, the intersection area AR is an area in which a vehicle traveling on the first road R1 can enter the second road R2 or a vehicle traveling on the second road R2 can enter the first road RE The intersection area AR is, for example, an area between a position P3 and a position P4, which includes a third lane L3 and a fourth lane L4.

A separation band OB1A, a separation band OB2A, and a prohibition display SA that indicates that a vehicle cannot enter are displayed on the road between the first road R1 and the second road R2 on an upstream side (opposite to the traveling direction of the vehicle) of the intersection area AR. The separation band OB1A is provided up to the position P1 in the traveling direction. The separation band OB2A is, for example, provided from the position P1 to the position P2 in the traveling direction. The prohibition display SA is provided from the position P2 to the position P3 in the traveling direction. The position P3 is a position in which the vehicle traveling on the second road R2 can enter the first road R1 (the vehicle traveling on the first road R1 can enter the second road R2). The separation band OB1A is, for example, a separation band with a height at which the vehicle traveling on the first road R1 cannot visually recognize the vehicle traveling on the second road R2. The separation band OB2A is, for example, a separation band with a height at which the vehicle traveling on the first road R1 can visually recognize the vehicle traveling on the second road R2.

The first road R1 has, for example, a plurality of lanes. The plurality of lanes include, for example, a first lane L1, a second lane L2, and a third lane L3. On the first road R1, the first lane L1 disappears in the vicinity of the position P2 (before the position P2). The first lane L1 is formed from the vicinity of the position P5. The second road R2 has, for example, a plurality of lanes. The plurality of lanes include, for example, a fourth lane L4, a fifth lane L5, and a sixth lane L6.

For example, exits for specific roads including the first road R1 and the second road R2 are provided on a side of the intersection area AR on the first road R1 in a traveling direction of the vehicle M (ahead of the intersection area on the first road in a traveling direction of the vehicle, on a side of a travelling direction of the vehicle with respect to intersection area). In a section from a vicinity in which the first lane L1 disappears (a vicinity of the position P2) to a vicinity in which the first lane L1 is formed (a vicinity of the position P5), the second lane L2 and the third lane L3 are curved toward the second road side. A prohibition display SB that indicates that a vehicle cannot enter from the position P4 to the position P5 is displayed on the road. A separation band OB2B is provided from the position P5 to a position P6, and a separation band OB1B is provided from the position P6,

For example, when other vehicle m traveling in front of the vehicle M is present on the second road R2, the following processing is executed at a time t+1. The action controller 146 estimates a time at which the vehicle M will reach the intersection area AR. For example, the action controller 146 estimates a time at which the vehicle M will reach the intersection area AR under normal control on the basis of current traveling conditions of the vehicle M, a distribution of other vehicles present on the first road R1, traveling conditions (speed and acceleration) of other vehicles, and the like. The normal control is control when the vehicle M has traveled on the first road R1 without considering the time at which the vehicle traveling on the second road R2 (for example, other vehicle m) will reach the intersection area AR. For example, it is assumed that the vehicle M reaches the intersection area AR at a time tx.

The action controller 146 predicts the time at which the other vehicle m heading from the second road to a first road side will reach the intersection area AR on the basis of a result of prediction performed by the predictor 142. For example, as shown in FIG. 3, it is assumed that the other vehicle m will reach the intersection area AR at the time tx.

The action controller 146 determines, for example, whether the other vehicle m will reach the intersection area AR within a range of a predetermined time from a reference time. The reference time is the time tx at which the vehicle M will reach the intersection area AR. The range of a predetermined time is, for example, a time before the reference time tx, a time before or after the reference time tx, or a time after the reference time tx. For example, as shown in FIG. 3, when the vehicle M and other vehicle m reach the intersection area AR at the time tx (when the other vehicle m reaches the intersection area AR within a predetermined time range), the action controller 146 determines whether to cause the vehicle M to pass through the intersection area AR with priority over the other vehicle m on the basis of the state of the vehicle M and a future position of the other vehicle m. That is, when a timing at which the other vehicle m will reach the intersection area AR is within a predetermined time from a timing at which the vehicle M will reach the intersection area AR, the action controller 146 determines whether to cause the vehicle M to pass through the intersection area AR with priority over the other vehicle m.

The action controller 146 determines whether to cause the vehicle M to pass through the intersection area AR with priority over the other vehicle m on the basis of traffic conditions of the first road R1 or the traffic conditions of the first road R1 and the second road R2. For example, when the vehicle M can reach the intersection area AR earlier than the other vehicle m by a predetermined time, it is determined that the vehicle M is caused to pass through the intersection area AR with priority over the other vehicle m.

### Situation 1

FIG. 4 is a diagram (part 1) which shows an example of a situation in which the vehicle M passes through the intersection area AR with priority over the other vehicle m. Differences from FIG. 3 will be mainly described. For example, it is assumed that the vehicle M and the other vehicle m enter the intersection area AR and are traveling parallel to each other at a time t+2 (more accurately, it is assumed that the other vehicle m is present slightly in front of the vehicle M). At a time t+3, the vehicle M overtakes the other vehicle m, and the other vehicle m changes lanes from the fourth lane L4 to the third lane L3 after being overtaken by the vehicle M and travels behind the vehicle M. At a time t+4, the vehicle M changes lanes from the third lane L3 to the fourth lane L4 or the fifth lane L5, and the other vehicle m changes lanes to the second lane L2.

At a time t+5, the vehicle M travels in the sixth lane L6, and the other vehicle m travels in the second lane L2. At a time t+6, the vehicle M travels in the sixth lane L6, and the other vehicle m travels in the first lane L1.

As described above, the action controller 146 can allow the vehicle M to travel more smoothly by causing the vehicle to enter the second road R2 from the first road R1 in front of the other vehicle m in the intersection area AR.

### Situation 2

FIG. 5 is a diagram (part 2) which shows an example of the situation in which the vehicle M passes through the intersection area AR with priority over the other vehicle m. Differences from FIG. 3 will be mainly described. For example, at the time t+1, it is assumed that the action controller 146 has predicted that the vehicle M will enter the intersection area AR at the time t+2, the other vehicle m will also enters the intersection area AR at the time t+2, and the other vehicle m is present in front of the vehicle M (or the vehicle M and the other vehicle m are traveling parallel to each other) under normal control. In this case, the action controller 146 controls the vehicle M such that the vehicle M travels in front of the other vehicle m at the time t+2. That is, the action controller 146 performs control different from the normal control and controls the vehicle M such that a traveling degree is greater than a traveling degree under the normal control.

If the vehicle M is controlled such that the traveling degree is increased as described above, at the time t+2, the vehicle M in the third lane L3 travels in front of the other vehicle m in the fourth lane L4. At the time t+3, the vehicle M changes lanes from the third lane L3 to the fifth lane L5, and the other vehicle m changes lanes from the fourth lane L4 to the third lane L3. After the time t+4, the vehicle M travels in front of the other vehicle m in the sixth lane L6. At the time t+4 and the time t+5, the other vehicle m travels behind the vehicle M in the second lane L2. At the time t+6, the other vehicle m travels behind the vehicle M in the first lane L1.

As described above, the action controller 146 allows the vehicle M to travel more smoothly by causing the vehicle to pass through the intersection area earlier than the timing at which the other vehicle passes through the intersection.

### Situation 3

When a density of vehicles on a road (the second road R2) on which the other vehicle m is present exceeds a threshold value, or when an average speed of the vehicles traveling on the road on which the other vehicle m is present is equal to or less than a threshold value, the action controller 146 determines whether to prioritize passing of the vehicle M through the intersection area AR over the other vehicle m, and controls the vehicle M on the basis of a result of the determination. The action controller 146 may also determine whether to prioritize the passing of the vehicle M through of the intersection area AR on the basis of the density of vehicles in a predetermined lane of the second road R2 or the average speed of the vehicles traveling in the predetermined lane. The predetermined lane is, for example, a fourth lane R4 adjacent to the first road R1.

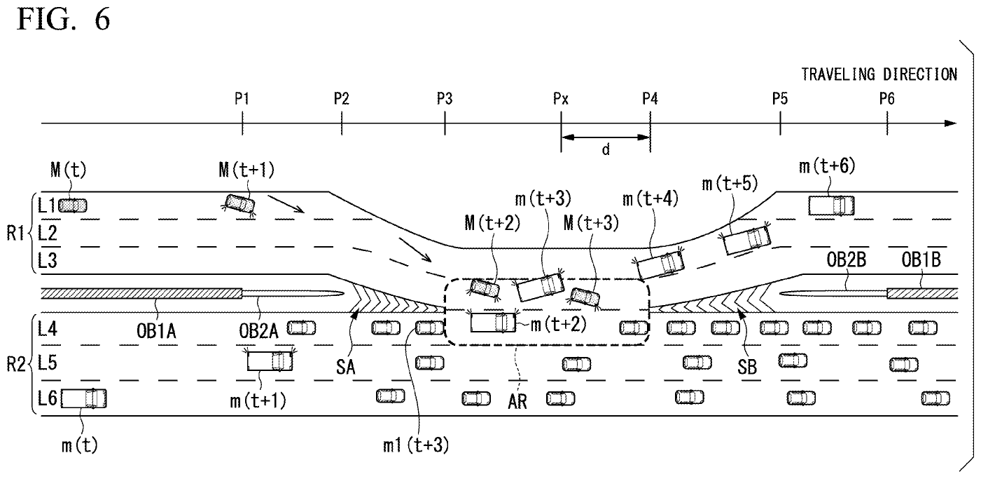

FIG. 6 is a diagram (part 3) which shows an example of the situation in which the vehicle M passes through the intersection area AR with priority over the other vehicle m. Differences from FIG. 3 and FIG. 4 will be mainly described. For example, at the time t+1, the action controller 146 executes specific control when it is determined that the density of vehicles on the second road exceeds a threshold value on the basis of the traffic conditions of the second road R2. Then, the vehicle M is caused to pass through the intersection area AR with priority over the other vehicle m as shown in FIG. 4.

For example, at the time t+3, it is assumed that the vehicle M which is present in the third lane L3 has overtaken the other vehicle m, and the other vehicle m has changed lanes from the fourth lane L4 to the third lane L3 and entered behind the vehicle M. In this case, even if the fourth lane L4 is congested, the vehicle M can easily change a lane to the fourth lane L4. This is because the vehicle M can change a lane to the fourth lane L4 so as to be replaced with the other vehicle m at a timing at which the other vehicle m changes lanes to the third lane L3. For example, the vehicle M can enter in front of other vehicle m1 that has traveled behind the other vehicle m in the fourth lane L4.

The action controller 146 does not execute processing of determining whether to cause the vehicle M to pass through the intersection area AR with priority over the other vehicle m and controlling the vehicle M on the basis of a result of the determination (the action controller 146 does not control the vehicle M on the basis of a result of the determination) when the vehicle M has approached a position (a position Px) at a predetermined distance d from an end point (for example, the position P4) of the intersection area AR. The action controller 146 ends processing of the specific control when the vehicle M does not overtake the other vehicle m at a position of the predetermined distance d upstream from the position P4. In this case, for example, the action controller 146 may allow the vehicle M to enter the second road R2 behind the other vehicle m, or allow the vehicle M to enter the second road R2 and enter the front of other vehicle allowing an entry of the vehicle M traveling in the fourth lane L4.

### Comparison With Comparative Example

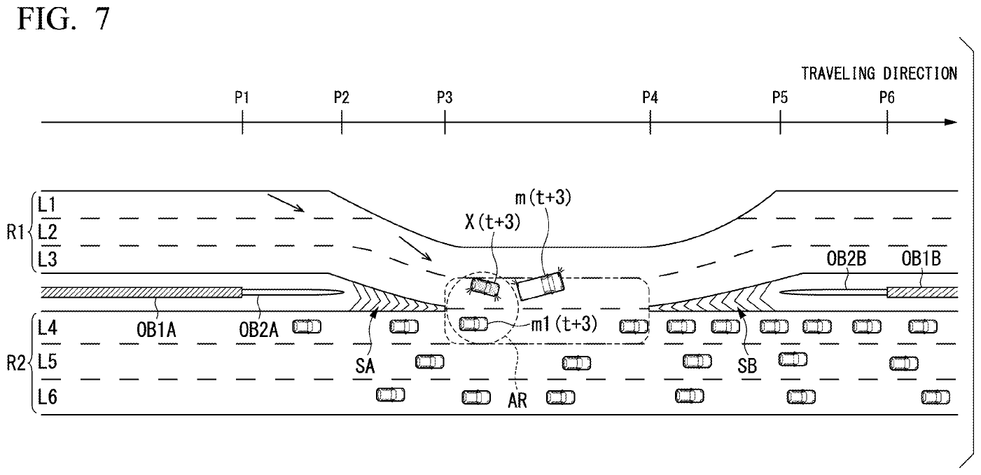

FIG. 7 is a diagram which shows an example of a situation in which a vehicle X of a comparative example enters the second road R2 without executing the specific control. States of the vehicle X, the other vehicle m, and the other vehicles at the time t+3 are shown. For example, the other vehicle m changes lanes from the fourth lane L4 to the third lane L3, and the vehicle X travels behind the other vehicle m traveling in the third lane L3. In this case, the other vehicle m1 having traveled behind the other vehicle m in the fourth lane L4 travels to an area in which the other vehicle m has been present in the fourth lane L4. For this reason, the other vehicle m1 and the vehicle X may travel side by side. As described above, when the specific control is not executed, it may be difficult to change a lane of the vehicle X to the fourth lane L4, and the vehicle may not travel smoothly.

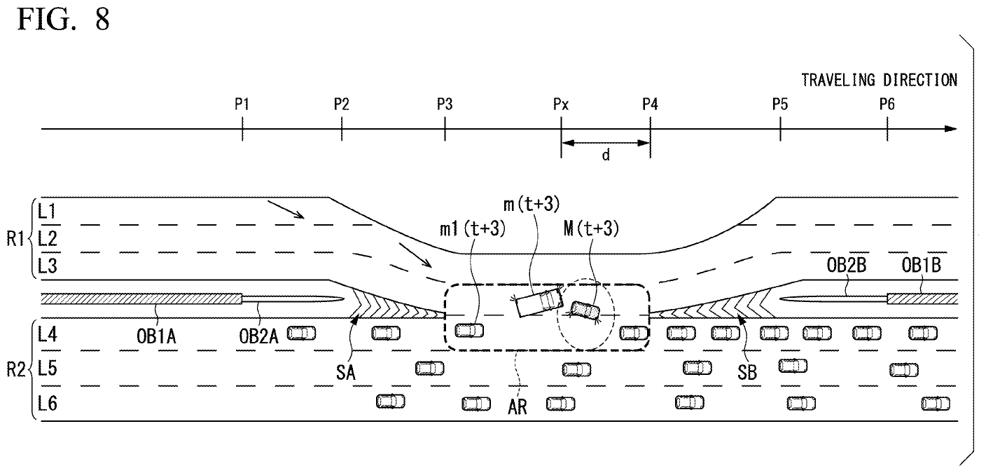

On the other hand, in the present embodiment, the vehicle M can smoothly change lanes to the fourth lane L4 by executing the specific control. FIG. 8 is a diagram which shows an example of a situation in which the vehicle M executes the specific control and enters the second road R2. For example, the vehicle M overtakes the other vehicle m and changes lanes to the fourth lane L4 at a timing at which the other vehicle m changes lanes to the third lane L3. In this case, the other vehicle m1 in the fourth lane L4 may travel behind the other vehicle m and the vehicle M and the other vehicle m1 may not travel side by side. For this reason, there is an area on a side of the vehicle M for the vehicle M to enter. In this manner, when the specific control is executed, the vehicle M may easily change lanes to the fourth lane L4, and the vehicle may travel smoothly.

### Flowchart

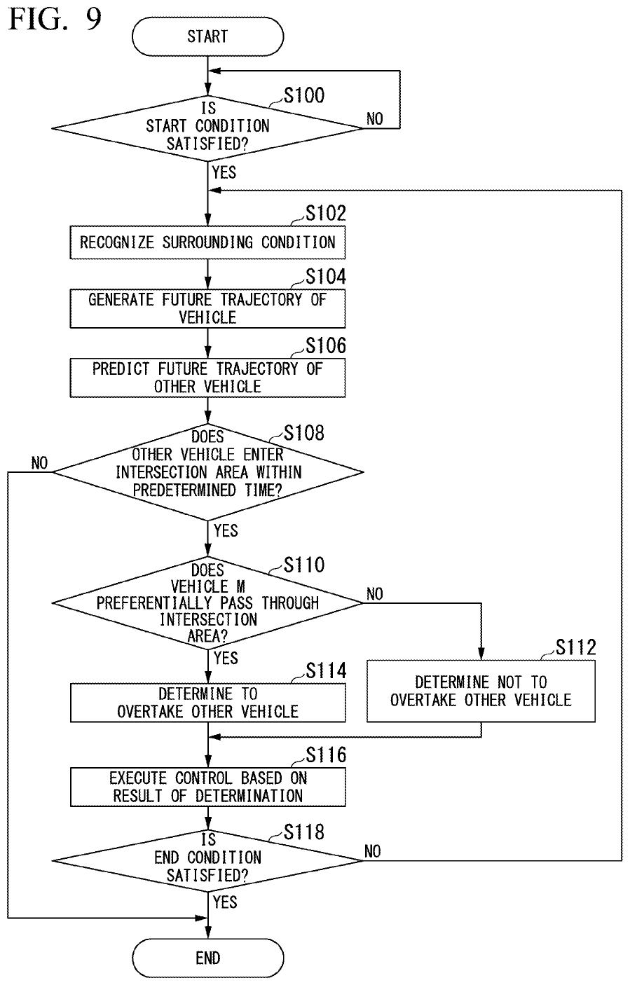

FIG. 9 is a flowchart which shows an example of a flow of processing executed by the automated driving control device 100. First, the action controller 146 determines whether a start condition of the specific control is satisfied (step S100). The “start condition” is, for example, a timing at which the vehicle M has reached a predetermined position. The predetermined position is, for example, the position P1 or a predetermined distance upstream away from the intersection area AR.

When the start condition of the specific control is satisfied, the recognizer 130 recognizes surrounding conditions (step S102). Next, the action plan generator 140 generates a future trajectory of the vehicle M (step S104). Next, the predictor 142 predicts a future trajectory of the other vehicle m on the basis of a result of the recognition of the recognizer 130 (step S106).

Then, the action controller 146 determines whether the other vehicle m enters the intersection area AR at a predetermined time from the time at which the vehicle M will reach the intersection area AR (step S108). When it is determined that the other vehicle m does not enter the intersection area AR, processing of this flowchart ends.

When it is determined that the other vehicle m enters the intersection area AR, the action controller 146 determines whether to cause the vehicle M to pass through the intersection area AR with priority over the other vehicle m (step S110).

When the vehicle M is not caused to preferentially pass through the intersection area AR, the action controller 146 determines not to overtake the other vehicle m (step S112) and executes control based on a result of the determination (step S116). In this case, the vehicle M travels behind the other vehicle m1 and enters the second road R2 from the first road R1.

When the vehicle M is caused to preferentially pass through the intersection area AR, the action controller 146 determines to overtake the other vehicle m (step S114) and executes control based on a result of the determination (step S116). In this case, the vehicle M overtakes the other vehicle m1, travels in front of the other vehicle m1, and enters the second road R2 from the first road R1.

Next, the action controller 146 determines whether an end condition of the specific control is satisfied (step S118). The end condition is, for example, that the vehicle M approaches a position the predetermined distance d from the end point of the intersection area AR. The procedure returns to processing of step S102 when the end condition of the specific control is not satisfied, and the processing of this flowchart ends when the end condition of the specific control is satisfied.

As described above, the action controller 146 can cause the vehicle to travel more smoothly by determining whether to cause the vehicle M to pass through the intersection area AR with priority over the other vehicle m on the basis of the future position of the other vehicle m.

According to the first embodiment described above, the automated driving control device 100 determines whether to cause the vehicle M to pass through the intersection area AR with priority over the other vehicle m and controls the vehicle M on the basis of a result of the determination, thereby causing the vehicle M to travel more smoothly.

### Second Embodiment

Hereinafter, a second embodiment will be described. In the second embodiment, when the vehicle M enters the first road from the second road R2, the specific control is executed. In the following description, differences of the second embodiment from the first embodiment will be mainly described.

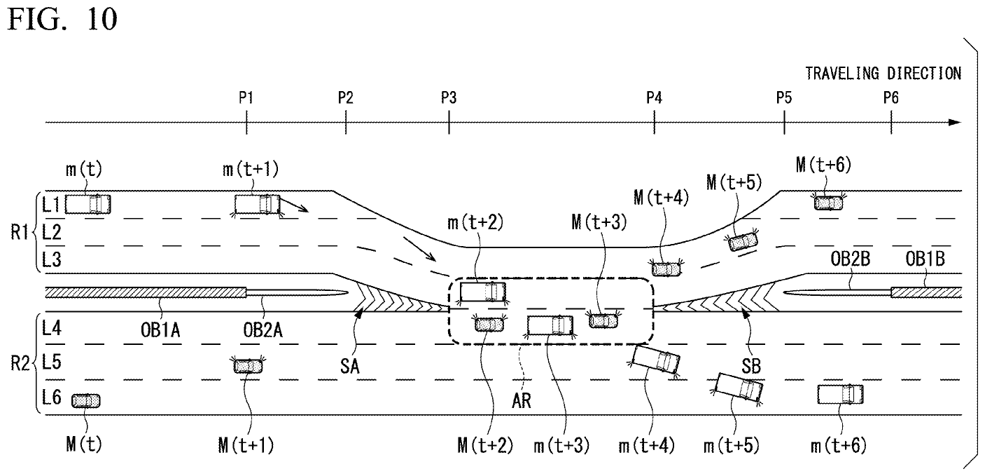

FIG. 10 is a diagram which shows an example of a situation in which the specific control is executed in the second embodiment. Differences from FIG. 3 will be mainly described. For example, it is assumed that the vehicle M is traveling in the sixth lane L6 and the other vehicle m is traveling in the first lane L1 at the time t. The vehicle M is traveling in the fifth lane L5 and the other vehicle m is traveling in the first lane L1 at the time t+1. When it is predicted that the other vehicle m will reach the intersection area AR at the same timing as the timing at which the vehicle M will reach the intersection area AR under normal control, the action controller 146 executes the specific control.

The vehicle M overtakes the other vehicle m, and the other vehicle m changes lanes from the third lane L3 to the fourth lane L4 and travels behind the vehicle M after being overtaken by the vehicle M at the time t+3. The vehicle M changes lanes from the fourth lane L4 to the second lane L2 at the time t+4.

According to the second embodiment described above, it is possible to cause the vehicle M to travel more smoothly even when the vehicle M enters a merging lane, an exit, or a branch road from a main line.

### Third Embodiment

Hereinafter, a third embodiment will be described. In the third embodiment, the action controller 146 determines whether to overtake a vehicle mA in front, which travels on the first road R1, when the vehicle M passes through the intersection area AR with priority over the other vehicle m. In the following description, differences of the third embodiment from the first embodiment will be mainly described.

When there is a vehicle in front, which is predicted to pass through the intersection area AR in front of a road on which the vehicle M travels, the action controller 146 determines whether to overtake the vehicle in front and to cause the vehicle M to pass through an intersection area prior to other vehicle and executes processing of controlling the vehicle on the basis of a result of the determination. For example, the action controller 146 determines whether the vehicle M can overtake the preceding vehicle mA and the other vehicle m on the basis of current traveling conditions of the vehicle M, a distribution of other vehicles present on the first road R1 and the second road R2, traveling conditions (speed or acceleration) of the other vehicles, or the like.

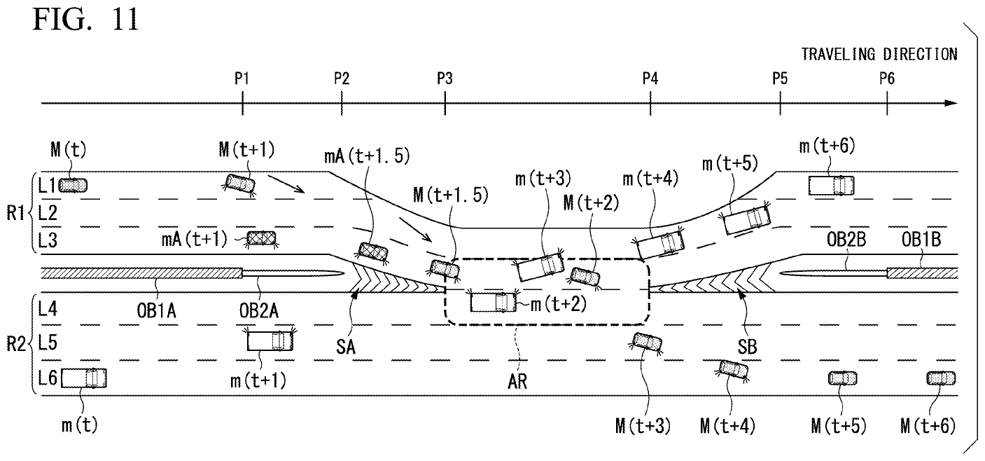

FIG. 11 is a diagram which shows an example of a situation in which the specific control is executed in the third embodiment. Differences from FIG. 4 will be mainly described. For example, the preceding vehicle mA is traveling in front of the vehicle M in the third lane L3 at the time t+1. The preceding vehicle mA causes a turn signal to blink to indicate that it will enter the second road R2. For example, the action controller 146 determines whether the vehicle M can overtake the preceding vehicle mA before entering the intersection area AR and determines whether it can overtake the other vehicle m before reaching a predetermined position in the intersection area AR after overtaking the preceding vehicle mA.

When it is determined that the vehicle M can overtake the preceding vehicle mA and the other vehicle m, the action controller 146 causes the vehicle M to overtake the other vehicle and the preceding vehicle mA at a time t+1.5. Then, the vehicle M starts to change lanes toward the fourth lane L4 at the time t+2, and the vehicle M travels in the fifth lane L5 at the time t+3 and travels in the sixth lane L6 thereafter.

As described above, the vehicle M can overtake the preceding vehicle mA traveling on the first road R1 and then perform a lane change by overtaking the other vehicle m traveling on the second road R2, thereby allowing the vehicle to travel more smoothly.

### Flowchart

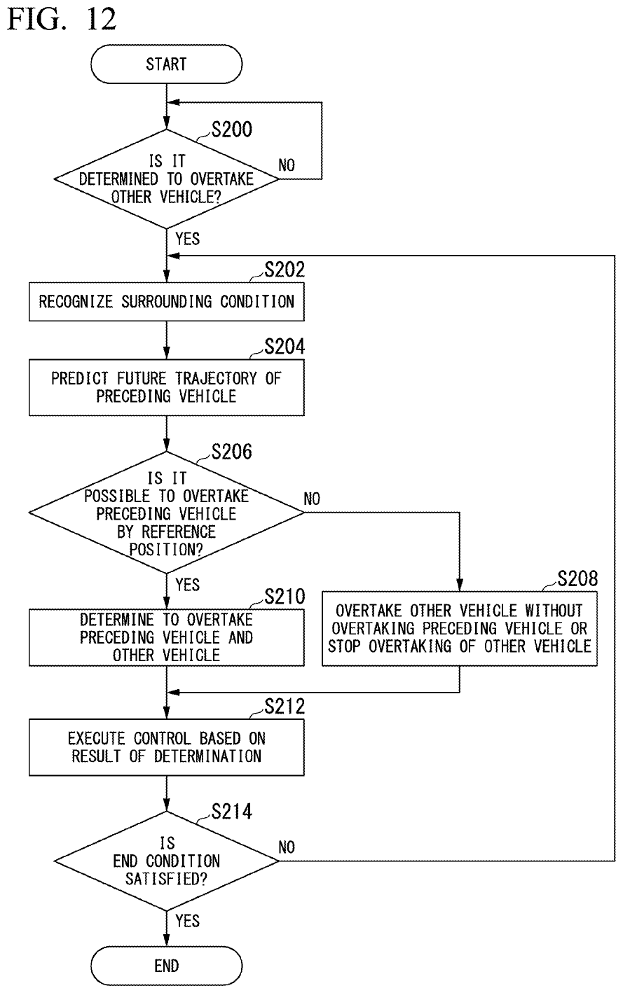

FIG. 12 is a flowchart which shows an example of a flow of processing executed by the automated driving control device 100 of the third embodiment. This processing is executed, for example, in parallel with processing of the flowchart of FIG. 9 after the processing of the flowchart of FIG. 9 is started.

First, the action controller 146 determines whether it is determined to overtake the other vehicle m (step S200). When it is determined to overtake the other vehicle m, the recognizer 130 recognizes surrounding conditions (step S202). Next, the predictor 142 predicts a future trajectory of the preceding vehicle mA (step S204). Next, the action controller 146 determines whether it is possible to overtake the preceding vehicle mA by a reference position (step S206). The reference position is, for example, a position on a near side at a predetermined distance from the intersection area AR.

When it is determined that it is not possible to overtake the preceding vehicle mA by the reference position, the action controller 146 causes overtaking of the other vehicle m without overtaking the preceding vehicle mA or stops overtaking of one or both of the preceding vehicle mA and the other vehicle m (step S208). For example, when it is possible to overtake the other vehicle m without overtaking the preceding vehicle mA, the vehicle M overtakes the other vehicle m.

When it is determined that it is possible to overtake the preceding vehicle mA by the reference position, the action controller 146 determines to overtake the preceding vehicle mA and the other vehicle m (step S210). Next, the action controller 146 executes control based on a result of the determination (step S212). Next, the action controller 146 determines whether the end condition is satisfied (step S214). The procedure returns to processing of step S202 when the end condition is not satisfied, and processing of this flowchart ends when the end condition is satisfied.

As described above, the action controller 146 can determine whether to overtake the other vehicle m and the preceding vehicle mA, and perform control based on a result of the determination. As a result, it is possible to further realize the traveling of the vehicle M according with a traffic environment.

The processing described above may be applied even when the vehicle M moves from the second road R2 to the first road R1. That is, when the vehicle M is caused to change lanes from the second road R2 to the first road R1, the action controller 146 may determine whether to overtake a vehicle in front, which travels on the second road R2, and to cause the vehicle M to pass through the intersection area AR with priority over the other vehicle.

According to the third embodiment described above, when there is the vehicle in front mA, which is predicted to pass through the intersection area AR in front of the road on which the vehicle M travels, the action controller 146 determines whether to overtake the vehicle in front mA and to cause the vehicle M to pass through the intersection area AR with priority over the other vehicle m and executes processing of controlling the vehicle M on the basis of a result of the determination, thereby allowing the vehicle to travel more smoothly.

### Fourth Embodiment

Hereinafter, a fourth embodiment will be described. In the fourth embodiment, the action controller 146 executes specific control when a specific control mode is set. In the following description, differences of the fourth embodiment from the first embodiment will be mainly described.

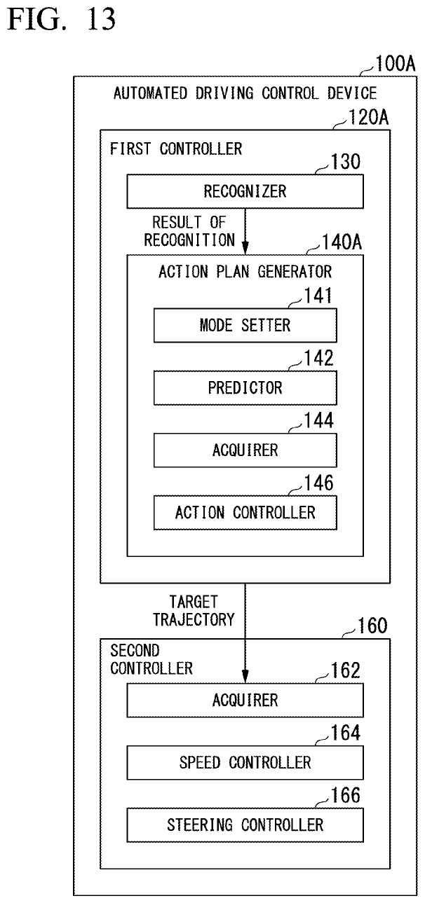

FIG. 13 is a diagram which shows an example of functional constituents of an automated driving control device 100A of the fourth embodiment. The automated driving control device 100A includes a first controller 120A. The first controller 120A includes an action plan generator 140A. The action plan generator 140A further includes a mode setter 141 in addition to the functional constituents of the action plan generator 140 of the first embodiment.

The mode setter 141 sets any one of a plurality of control modes.

The control modes include, for example, a specific control mode in which specific control is executed and a control mode in which the specific control is not executed. For example, the mode setter 141 sets a control mode on the basis of an operation performed by the occupant on the HMI 30. The mode setter 141 may also set the control mode as the specific control mode on the basis of utterance of the occupant, which is input to a microphone provided in the vehicle M.

The action controller 146 executes specific control when the specific control mode is set by the mode setter 141 and performs control based on a control mode set by the mode setter 141 without executing the specific control when the specific control mode is not set by the mode setter 141.

The mode setter 141 may also perform setting of automatically changing the control mode to the specific control mode when a scheduled arrival time of the vehicle M to a destination is later than a set target time by a predetermined time or more.

As described above, the automated driving control device 100A can execute the specific control and quickly move to the destination when the vehicle M needs to quickly move to the destination. As a result, convenience of a user is improved.

According to the fourth embodiment described above, the automated driving control device 100A can curb unnecessary control to execute the specific control when the specific control mode is set, and execute the specific control in a situation in which the need is high.

### Fifth Embodiment

Hereinafter, a fifth embodiment will be described. In the fifth embodiment, the action controller 146 controls the vehicle M on the basis of a result of control performed by a control device provided at a position different from the vehicle M. That is, the vehicle M is remotely operated by the control device. In the following description, differences of the fifth embodiment from the first embodiment will be mainly described.

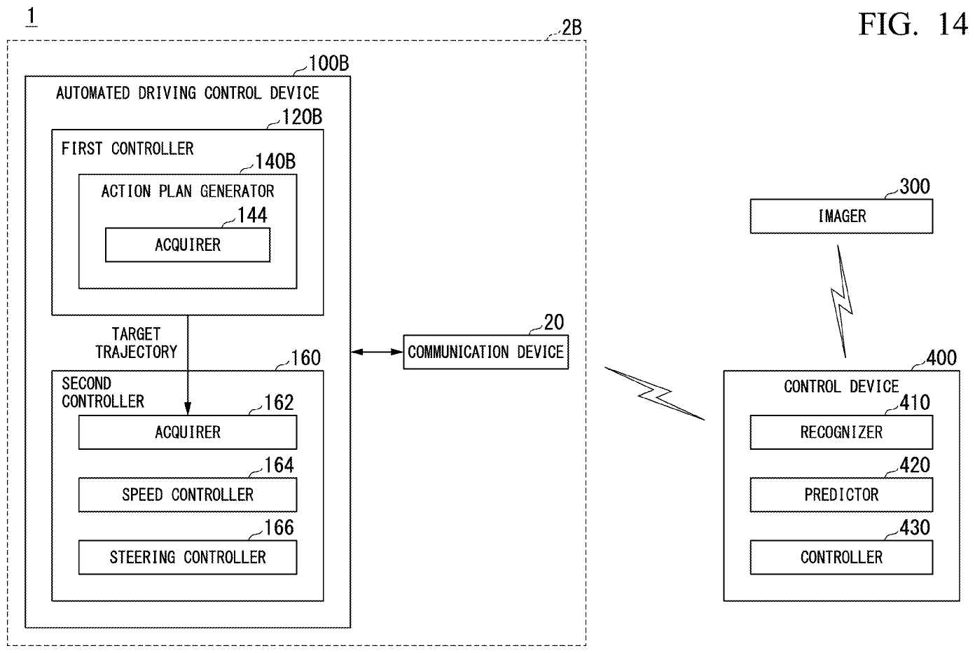

FIG. 14 is a diagram which shows an example of functional constituents of a vehicle control system 1 according to the fifth embodiment. The vehicle control system 1 includes, for example, a vehicle system 2B, an imager 300, and a control device 400. The vehicle system 2B communicates with the control device 400, and the imager 300 communicates with the control device 400. The vehicle system 2B and the control device 400 communicate with each other and transmit or receive information necessary for the vehicle M to automatically travel on the first road R1 or the second road R2.

### Imager

The imager 300 is a camera that captures an image of a vicinity of a merging point at which the first road R1 and the second road R2 shown in FIG. 3 and the like merge. The imager 300 captures, for example, an image of a vicinity of the merging point (a vicinity of the area shown in FIG. 3 and the like) in an overlooking direction. The example of FIG. 14 shows one imager 300, but the vehicle control system 1 may also include a plurality of imagers 300.

### Vehicle System

The vehicle system 2B includes an automated driving control device 100B instead of the automated driving control device 100. In FIG. 14, functional constituents other than the automated driving control device 100B and the communication device 20 are not shown. The automated driving control device 100B includes a first controller 120B and the second controller 160. The first controller 120B includes an action plan generator 140B. The action plan generator 140B includes, for example, the acquirer 144.

### Control Device

The control device 400 includes, for example, a recognizer 410, a predictor 420, and a controller 430. The recognizer 410 recognizes vehicles, lanes, objects necessary for the vehicle M to travel, displays, and the like in the vicinity of the merging point on the basis of an image captured by the imager or on the basis of pattern matching, deep learning, or other image processing methods. For example, the recognizer 410 has the same function as the recognizer 130. The predictor 420 has the same function as the predictor 142.

The controller 430 has the same function as the action plan generator 140 of the first embodiment. However, in the controller 430, functions of the predictor 142 and the acquirer 144 of the first embodiment are omitted. The controller 430 causes the vehicle M to travel in a recommended lane (a recommended lane that is information transmitted to the vehicle M) determined by the recommended lane determiner 61, in principle, and, furthermore, generates a target trajectory in which the vehicle M will automatically travel to be able to respond to the surrounding conditions of the host vehicle M. As described in the first embodiment, the controller 430 sets an event for automated driving such as a merging event and generates a target trajectory in accordance with the event when the target trajectory is generated.

In a case in which the vehicle M heads from the first road R1 that is a merging road toward the second road R2 that is a merged road while traveling and the other vehicle m heads from the second road R2 to the first road R1, when a future trajectory in which the vehicle M will travel and a future trajectory in which the other vehicle m will travel intersect with each other, the controller 430 determines whether to cause the vehicle M to pass through an intersection area in which the first road R1 and the second road R2 intersect with each other with priority over the other vehicle m on the basis of the state of the vehicle M and the future position of the other vehicle m. Then, the controller 430 generates a trajectory on the basis of a result of the determination. Then, the generated target trajectory is transmitted to the automated driving control device 100B.

The automated driving control device 100B causes the vehicle M to travel on the basis of the target trajectory transmitted by the control device 400. In the example described above, it is assumed that the target trajectory is generated by the control device 400, but the target trajectory may also be generated by the automated driving control device 100B. In this case, the controller 430 of the control device 400 determines whether to allow the vehicle M to overtake other vehicle and transmits a result of the determination to the automated driving control device 100B. In this case, the automated driving control device 100B includes the recognizer 130.

According to the fifth embodiment described above, the control device 400 supports the traveling of the vehicle M, and thereby a processing load on a vehicle side is reduced.

Some of the processing of each flowchart described above may be omitted, and an order of the processing may be appropriately changed. The embodiments described above may be combined and implemented. For example, contents of the processing from the first embodiment to the fourth embodiment may also be applied in the vehicle control system 1 of the fifth embodiment.

### Hardware Configuration

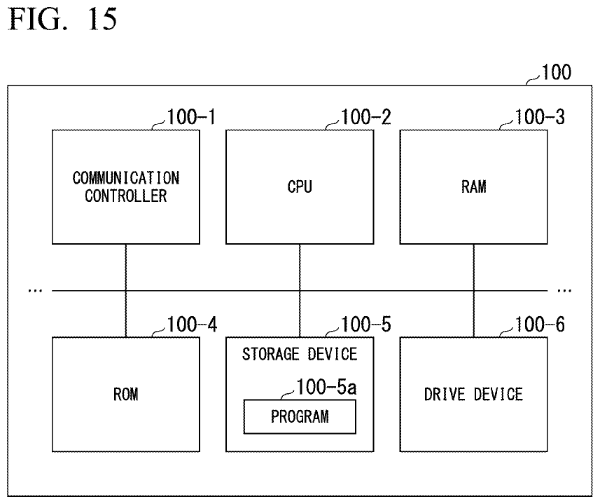

FIG. 15 is a diagram which shows an example of a hardware configuration of the automated driving control device 100 according to the embodiment. As shown in FIG. 15, the automated driving control device 100 is configured to include a communication controller 100-1, a CPU 100-2, a random access memory (RAM) 100-3 used as a working memory, a read only memory (ROM) 100-4 that stores a booting program and the like, a storage device 100-5 such as a flash memory or a hard disk drive (HDD), a drive device 100-6, and the like being connected to each other by an internal bus or a dedicated communication line. The communication controller 100-1 communicates with components other than the automated driving control device 100. The storage device 100-5 stores a program 100-5a executed by the CPU 100-2. This program is expanded in the RAM 100-3 by a direct memory access (DMA) controller (not shown) or the like and executed by the CPU 100-2. As a result, some or all of the recognizer 130 and the action plan generator 140 are realized.

The embodiment described above can be expressed as follows.

A vehicle control device includes a storage device that stores a program, and a hardware processor, in which the hardware processor executes the program stored in the storage device, and thereby the vehicle control device is configured to acquire a state of a vehicle, a current position of other vehicle present in the surroundings of the vehicle, and a predicted future position of the other vehicle, control an action of the vehicle on the basis of the acquired information, and, when the vehicle heads from a first road that is a merging road toward a second road which at least partially intersects with the first road while traveling, other vehicle heads from the second road to a first road side, and a future trajectory in which the vehicle travels and a future trajectory in which the other vehicle travels intersect with each other, determine whether to cause the vehicle to pass through an intersection area in which the first road and the second road intersect with each other with priority over the other vehicle on the basis of the state of the vehicle and the future position of the other vehicle, and control the vehicle on the basis of a result of the determination.

A mode for implementing the present invention has been described using the embodiment. However, the present invention is not limited to such an embodiment, and various modifications and substitutions may be made within a range not departing from the gist of the present invention.

What is claimed is:

1. A vehicle control device comprising:
an acquirer configured to acquire a state of a vehicle, a current position of other vehicle present in surroundings of the vehicle, and a predicted future position of the other vehicle; and
an action controller configured to control an action of the vehicle on the basis of information acquired by the acquirer,
wherein, when the vehicle heads from a first road toward a second road which at least partially intersects with the first road while traveling, other vehicle heads from a second road toward a first road side, and a future trajectory in which the vehicle travels and a future trajectory in which the other vehicle travels intersect with each other, the action controller determines whether to cause the vehicle to pass through an intersection area in which the first road and the second road intersect with each other with priority over the other vehicle on the basis of the state of the vehicle and the future position of the other vehicle and controls the vehicle on the basis of a result of the determination.

2. The vehicle control device according to claim 1,
wherein the first road is a road that merges with the second road and disappears after a predetermined distance, and the second road is a road that does not disappear after the predetermined distance, or
the second road is a road that merges with the first road and disappears after a predetermined distance, and the first road is a road that does not disappear after the predetermined distance.

3. The vehicle control device according to claim 1, further comprising:
a recognizer configured to recognize surrounding conditions of the vehicle; and
a predictor configured to predict a future position of the other vehicle on the basis of a result of the recognition performed by the recognizer,
wherein the acquirer acquires a current position of the other vehicle recognized by the recognizer from the recognizer and acquires a future position of the other vehicle predicted by the predictor from the predictor.

4. The vehicle control device according to claim 1,
wherein the other vehicle is a vehicle that travels in front of the vehicle.

5. The vehicle control device according to claim 1,
wherein, when a timing at which the other vehicle will reach the intersection area is within a predetermined time from a timing at which the vehicle will reach the intersection area, the action controller determines whether to cause the vehicle to pass through the intersection area with priority over the other vehicle.

6. The vehicle control device according to claim 1,
wherein the action controller causes the vehicle to pass through the intersection area with priority over the other vehicle by causing the vehicle to pass through the intersection area at an earlier timing than a timing at which the other vehicle will pass through the intersection area.

7. The vehicle control device according to claim 1,
wherein the action controller causes the vehicle to pass through the intersection area with priority over the other vehicle by causing the vehicle to enter the second road from the first road in front of the other vehicle in the intersection area.

8. The vehicle control device according to claim 1,
wherein, when a density of vehicles on a road on which the other vehicle is present exceeds a threshold value or when an average speed of vehicles traveling on the road on which the other vehicle is present is equal to or less than a threshold value, the action controller determines whether to cause the vehicle to pass through the intersection area with priority over the other vehicle, and controls the vehicle on the basis of a result of the determination.

9. The vehicle control device according to claim 1,
wherein the action controller determines whether to cause the vehicle to pass through the intersection area with priority over the other vehicle and controls the vehicle on the basis of a result of the determination in a road environment in which the first road extends without disappearing in a vicinity of the intersection area on the first road and ahead of the intersection area in a traveling direction of the vehicle.

10. The vehicle control device according to claim 9,
wherein an exit of a specific road including the first road and the second road is provided ahead of the intersection area on the first road in a traveling direction of the vehicle.

11. The vehicle control device according to claim 1,
wherein, when the vehicle approaches a predetermined distance from an end point of the intersection area, the action controller does not execute processing of determining whether to cause the vehicle to pass through the intersection area with priority over the other vehicle and controlling the vehicle on the basis of a result of the determination.

12. The vehicle control device according to claim 1,
wherein, when there is a vehicle in front that is predicted to pass through the intersection area in front of the vehicle on the road on which the vehicle travels, the action controller executes processing of determining whether to overtake the vehicle in front and to cause the vehicle to pass through the intersection area with priority over the other vehicle and controlling the vehicle on the basis of a result of the determination.

13. The vehicle control device according to claim 12,
wherein the action controller determines whether to overtake the vehicle in front and to cause the vehicle to pass through the intersection area with priority over the other vehicle on the basis of a distribution of a vehicle group including the vehicle, the vehicle in front, and the other vehicle, and speed of vehicles included in the vehicle group.

14. A vehicle control method comprising:
by a computer,
acquiring a state of a vehicle, a current position of other vehicle present in surroundings of the vehicle, and a predicted future position of the other vehicle;
controlling an action of the vehicle on the basis of the acquired information; and
when the vehicle heads from a first road toward a second road which at least partially intersects with the first road while traveling, other vehicle heads from a second road toward a first road side, and a future trajectory in which the vehicle travels and a future trajectory in which the other vehicle travels intersect with each other,
determining whether to cause the vehicle to pass through an intersection area in which the first road and the second road intersect with each other with priority over the other vehicle on the basis of the state of the vehicle and the future position of the other vehicle and controlling the vehicle on the basis of a result of the determination.

15. A non-transitory computer-readable storage medium that is configured to store a computer program to be executed by a computer to perform at least:
acquire a state of a vehicle, a current position of other vehicle present in surroundings of the vehicle, and a predicted future position of the other vehicle;
control an action of the vehicle on the basis of the acquired information; and
when the vehicle heads from a first road toward a second road which at least partially intersects with the first road while traveling, other vehicle heads from a second road toward a first road side, and a future trajectory in which the vehicle travels and a future trajectory in which the other vehicle travels intersect with each other,
determine whether to cause the vehicle to pass through an intersection area in which the first road and the second road intersect with each other with priority over the other vehicle on the basis of the state of the vehicle and the future position of the other vehicle and control the vehicle on the basis of a result of the determination.
